(19) United States
(12) Patent Application Publication
(10) Pub. No.: US 2018/0179414 A1
(43) Pub. Date: Jun. 28, 2018

(54) HYDROXYLATED AND/OR CARBOXYLATED POLYESTER RESIN WITH HIGH SOLIDS CONTENT AND HIGH COVERING POWER FOR COATING OF METAL FOIL

(71) Applicant: Arkema France, Colombes (FR)

(72) Inventors: Frank Cogordan, Paris (FR); Herve OZERAY, Estrees Saint Denis (FR); Alain RIONDEL, Saint Pathus (FR)

(21) Appl. No.: 15/735,222

(22) PCT Filed: Jun. 8, 2016
(86) PCT No.: PCT/FR2016/051373

§ 371 Date: Dec. 11, 2017

(30) Foreign Application Priority Data
Jun. 17, 2015 (FR) 1555541

(51) Int. Cl. C09D 167/02; C08G 63/181; C08G 63/91; C08J 3/24; C09D 5/00; C08G 63/20

(52) U.S. Cl. CPC C09D 167/02; C08G 63/181; C08G 63/916; C08K 2003/2241; C09D 5/002; C08G 63/20; C08J 2367/02; C08J 3/24

(57) ABSTRACT

The invention is directed to a polyester resin bearing at least two functions from among hydroxyl and/or carboxyl, based on: A) a polyol component comprising a1) at least one diol bearing at least two lateral C₂ to C₄ alkyl substituents, a2) at least one diol bearing at least one lateral methyl substituent, a3) at least one C₂ to C₆ diol bearing no lateral substituent, a4) optionally, at least one polyol with functionality >2 and B) a polyacid component comprising b1) at least one aromatic diacid, b2) at least one linear C₄ to C₁₀ aliphatic diacid, b3) optionally, at least one cycloaliphatic diacid, said resin being free of any unsaturated fatty monoacid or monoalcohol. The invention is further directed to the polyester resin in solution in an organic solvent and crosslinkable compositions comprising it, particularly for metal foil coatings (“coils”).

The present invention relates to a hydroxylated and/or carboxylated polyester resin with specific composition, particularly characterized by compositions specifically selected from polyol components and polyacid components free of any unsaturated fatty monoalcohol or monoacid, particularly with no oil content for resins in a solvent medium with high solids content of at least 60%, preferably of at least 62%, more preferentially from 65 to 90% by weight and viscosity suitable for coatings with high solids content and high covering power, particularly for coatings for metal foils, commonly also called “coil coatings.”

The present invention relates to improving, through the specific structure of the binding resin used, the solids content with a weight content of at least 60%, preferably of at least 62% and more preferentially from 65 to 90%, even more preferentially from 70 to 85%, while maintaining a viscosity of the coating composition suitable for the final application, particularly for the application to metal foils otherwise also called “coil coating application.” This viscosity (Brookfleld) must be less than 1000 mPa·s at the application temperature ranging from 15 to 35° C., the Brookfield viscosity being measured according to the ISO 3219 method. Regarding the target resin, it must have a viscosity of less than 15 000 mPa·s in solution in an organic solvent at 25° C. with a resin content (solids content) of 80% by weight. Regarding the covering power of the final composition of this coating, it is preferably greater than 400 m² per kg of coating for a thickness of 1μ. Specifically, an increase of at least 10% and preferably from 10 to 20% of the covering power is obtained with a coating composition comprising said resin compared with a common polyester resin.

Compositions containing polyester, as defined according to the present invention, have the specific goal of improving the covering power of paints (yield) and meet a real need in the paint market, particularly for the coating of metal foils.

The present invention first relates to a hydroxylated or carboxylated polyester resin with a specific structure obtained from specific compositions of polyol components A) and polyacid components B).

It also relates to said resin in solution form in an organic solvent of said resin, particularly at a resin content relative to the weight of said solution ranging from 65 to 90%, preferably from 70 to 90% and more preferentially from 72 to 85%.

The invention also covers a crosslinkable composition comprising said resin, particularly a coating composition and more particularly a coating composition for metal foils (“coils”).

The use of said resin or a solution of said resin as binder in a coating composition in an organic solvent medium is also covered, particularly for crosslinkable coatings and more particularly to increase the covering power of said coating.

The invention further relates to the finished product which is a coating that results from the use of said resin or of a solution of said resin or of a crosslinkable composition containing it, particularly having increased (improved) covering power relative to other common polyester resins.

The first subject of the invention relates to a polyester resin bearing at least two functions from among hydroxyl and/or carboxyl, said resin having as components:
A) a polyol component comprising:
   a1) at least one C₃ to C₆ diol bearing (additionally) at least two lateral C₂ to C₄ alkyl substituents, particularly with said alkyls being different, preferably said diol being a C₃ or C₄ diol,
   a2) at least one C₃ to C₆ diol, bearing at least one lateral methyl substituent, particularly two lateral methyl substituents, preferably said diol being a C₃ or C₄ diol,
   a3) optionally, at least one linear C₂ to C₆ diol, bearing no lateral (alkyl) substituent,
   a4) optionally, at least one polyol with functionality >2 and preferably with functionality of 3 or 4, more preferentially of 3
   and
B) a polyacid component comprising:
   b1) at least one aromatic diacid or its anhydride, preferably representing from 20 to 75% by weight of said resin,
   b2) at least one linear C₄ to C₁₀, preferably C₄ to C₈, aliphatic diacid
   b3) optionally, at least one cycloaliphatic diacid
      preferably with the b1/b2 molar ratio ranging from 1/1 to 4/1, said resin being free of any unsaturated fatty monoacid and of any unsaturated fatty monoalcohol.

The term “a Cₙ diol” where n is the number of carbons, means that it has n linked carbon atoms (connected in a chain) besides the lateral substituents that are not counted in said number n.

More particularly and preferably, said diol a1) is 2-butyl-2-ethyl-1,3-propanediol.

According to a preferred option, the two components a3) and a4) are present as essential components with the other components a1), a2) and a3) as defined above.

Said diol a1) may represent at least 3%, preferably at least 5% by weight of said resin. More particularly, said diol a1) may represent from 3 to 25%, preferably from 5 to 20%, more preferentially from 5 to 15% by weight of said resin.

Specifically, when a3) is present, the a1/(a1+a2+a3) molar ratio varies from 0.1 to 0.4 and preferably from 0.1 to 0.3. More specifically, when a3) and a4) are present, the a1/(a1+a2+a3+a4) molar ratio varies from 0.1 to 0.4 and preferably from 0.1 to 0.3.

Like Diol a2), it may be selected from among: neopentyl glycol (2,2-dimethyl-1,3-propanediol) or dimethyl butanediol and preferably be neopentyl glycol. The content by weight of said polyol a2) is preferably less than 75% by weight of said polyol component A).

According to a specific composition of said resin, polyol a4) is present in addition to a1), a2) and a3) in said polyol component A), with the structure of said polyester resin being branched. A branched polyester resin structure here means that said polyester resin bears polyesters grafts on its main chain.

According to a specific composition of said resin, the acid component B) of said resin comprises (in addition to diacids b1) and b2)) at least one cycloaliphatic dicarboxylic acid b3) or its anhydride.

As aromatic diacid b1) or its anhydride, isophthalic acid, terephthalic acid, and phthalic anhydride may be cited.

As linear aliphatic diacid b2), adipic acid, succinic acid, and sebacic acid may be cited.

As cycloaliphatic diacid b3), cyclohexane dicarboxylic acid and hexahydrophthalic acid may be cited.

Said resin has a hydroxyl index or a carboxyl index or a global hydroxyl+carboxyl index that may range from 10 to 200, preferably from 15 to 175 (in mg KOH/g).

The OH index is measured according to the ISO 2554 method and the acid index according to the ISO 2114 method.

According to a specific option, said resin is a hydroxylated resin.

The glass transition temperature of said resin, measured by DSC at 10° C./min, (2nd passage) may vary from −10′C to 50° C., preferably from 0° C. to 30° C., with a calculated number average molecular weight Mn ranging from 500 to 10 000, preferably from 1000 to 10 000. The Mn value is calculated from the measured hydroxyl index and the measured acid index, which allow calculation of an equivalent mass M_{eq} per function (OH or carboxyl or sum of the two if both are present) and number average functionality of the resin, this average functionality fₘ being calculated from:

fₘ=Σᵢxᵢ*fᵢ/Σᵢxᵢ

where xᵢ is the number of moles of component i (acid or alcohol) and

fᵢ is the functionality of said component i

the equivalent mass M_{eq} is defined by M_{eq}=56 000/(I_{OH}+I_{acid})

So M_{n calculated}=M_{eq}*fₘ

The second subject of the invention relates to a resin solution comprising at least one resin as defined above according to the Invention and an organic solvent of said resin, particularly with a content of said resin over the total weight of resin+solvent (total solution weight) greater than 60%, preferably from 65 to 90%, more preferentially from 70 to 90% and even more preferentially from 72 to 85%.

As organic solvent suitable for preparing said resin solution, said solvent may be selected from among methyl esters or ethyl esters of C₂ to C₄ monocarboxylic acids or esters of said monocarboxylic acids with methoxy or ethoxy monoethers of C₂ to C₄ diols, particularly methoxy propyl acetate or among methyl or ethyl diesters of C₄ to C₆ carboxylic diacids, terpenes, polyhydroxyalkanoates, methyl or ethyl esters of fatty acid oils or esters of lactic acid with C₁ to C₈ alcohols, aromatic solvents such as xylene or other aromatic solvents that are distillation fractions of hydrocarbons including 9 carbon atoms with boiling point (b.p.) ranging from 155 to 180° C. like Solvarex® 9 or distillation fractions of aromatic hydrocarbons including 10 carbon atoms with b.p. ranging from 180 to 193° C. like Solvesso® 150 ND, optionally in mixtures with glycol monoethers such as butyl glycol (or butoxyethanol).

Preferably, said solvent is selected from among aromatic solvents, as defined above, alone or in mixtures with glycol monoethers, such as for example the mixture of a C₉ distillation fraction with b.p. ranging from 155 to 180° C. like Solvarex® 9 with butylglycol. The content by weight of said resin in said solution may vary from 60 to 90%, particularly from 62 to 90%, more particularly from 65 to 90% and even more particularly from 70 to 90% or between 70 and 90% and more preferentially from 72 to 85%. Said solvent may be the preparation solvent for said resin if prepared by polycondensation in a solvent medium or a dissolution solvent after preparation by bulk polycondensation. The solids content may be adjusted by extra addition of solvent if the resin is prepared at the start in a solvent. Said solvent may be a mixture of at least two solvents among those cited.

Said resin may be prepared by polycondensation reaction between the polyol component A) with the acid component B) as defined above. The reaction may take place in a solvent medium or when melted in bulk, as is already known to a person skilled in the art. When the reaction is conducted in the presence of a solvent as azeotropic carrier to remove the water, the solvent chosen preferentially is xylene.

The reaction is advantageously conducted in the presence of a catalyst. As catalyst, alkyl titanates may be used like, for example, isopropyl titanate, butyl titanate, 2-ethyl-hexyl titanate or tin derivatives like, for example, tin oxide, tin oxalate, monobutyl tin oxide. The quantities of catalyst used are comprised between 100 and 5000 ppm relative to all of the monomers and preferably from 500 to 1500 ppm still relative to all of the monomers.

Another important subject of the invention is a crosslinkable binder composition, which comprises as binder at least one polyester resin or a resin solution as defined above according to the Invention.

More particularly, said composition comprises at least one organic solvent as defined above, with the content of said resin ranging from 60% to 90%, preferably from 62 to 90%, more preferentially from 65 to 85%, and even more preferentially from 70 to 85% relative to the total weight of the resin together with the solvent.

Said composition is preferably a coating composition, particularly for metal foils (also known as “coil” application). This composition may apply to:
finishing coatings,
primer coatings,
backer coatings. These are coatings for the internal portion of the metal foil not exposed to poor weather or light.

Said crosslinkable composition, as well as said resin, may further comprise at least one crosslinking agent bearing groups that react with the hydroxyl and/or carboxyl groups borne by said resin. More specifically, said crosslinking agent is selected from among melamine or a polyisocyanate, particularly a blocked polyisocyanate or a polyanhydride or a polysilane, particularly a polysilane blocked by alkoxy when said resin is hydroxylated or said crosslinking agent is selected from among polyepoxides or polyols when said resin is carboxylated.

According to a specific preference, said composition is a coating composition in an organic solvent medium, particularly a paint or varnish composition, more particularly for metal surfaces (or “coils”).

Said composition may be pigmented and in this case it additionally comprises at least one pigment. More particularly, it comprises said resin, an organic solvent and a pigment.

Another specific subject covered by the present invention relates to the use of said resin or of a solution of said resin as defined above according to the invention as binder in coating compositions in an organic solvent medium, particularly in crosslinkable coating compositions.

According to a first option, said use relates to coatings compositions with “single-component” behavior for metals, particularly for metal foil (called “coil”) coating. “Single-component” behavior means that, in spite of the presence of two reagent components (resin and crosslinking agent), the crosslinkable composition remains stable when stored in ambient conditions. This is the case for blocked crosslinking agents like blocked isocyanates or blocked alkoxy silanes, which cannot react without prior unblocking by heating or hydrolysis. In the same way, melamines are suitable as crosslinking agents for this type of composition with hydroxylated polyesters because the reaction only takes place after prior heating. More particularly, such a coating composition with single-component behavior may comprise a hydroxylated resin as defined according to the invention, a preferred organic solvent as defined above and a crosslinking agent chosen from among blocked isocyanates (polyisocyanates), silanes blocked by alkoxy or melamines. A coating composition of this type with “single-component” behavior may be used for the coating of metal foils (also called “coils”).

More particularly, a primer, top-coat, backer or single-coat coating may be concerned.

According to another specific use, powdered coatings may also be concerned.

According to another specific use, “two-component” coatings are concerned. A “two-component” coating composition means that the crosslinking reaction starts when said resin is mixed with the crosslinking agent and consequently, said mixing (addition of the crosslinking agent) occurs at the moment of final application.

Preferably, said use of said resin or of said resin solution relates to a pigmented coating for increasing the covering power (yield) of said coating.

The last subject of the invention relates to the final product obtained, which is a coating, which results from the use of at least one resin or of at least one resin solution as defined above according to the invention or of a coating composition as also defined according to the invention. More particularly and preferably, said coating is a metal foil (also called “coil”) coating.

The examples outlined below are presented as Illustrations of the invention and of its performance qualities and do not in any way limit the invention.

### EXPERIMENTAL SECTION

### 1) Preparation of the Resin for Primer Coating

### 1.1) Raw Materials Used

TABLE 1
Raw materials used

| | | | | | Typical |
|---|---|---|---|---|---|
| | | | | Nature of the | composition |
| | Chemical | | Technical | function/ | according to the |
| Trade name | name | Supplier | function | functionality | invention |
| PAN | Phthalic | Polynt | Monomer | Carboxyl/2 | Diacid b1) |
| | anhydride | | | | |
| EG | Ethylene | Dow | Monomer | Hydroxyl/2 | Diol a3) |
| | glycol | | | | |
| NPG | Neopentyl | Perstorp | Monomer | Hydroxyl/2 | Diol a2) |
| | glycol | | | | |
| BEPD | Butyl ethyl | Perstorp | Monomer | Hydroxyl/2 | Diol a1) |
| | propanediol | | | | |
| AA | Adipic acid | Bayer | Monomer | Carboxyl/2 | Diacid b2) |
| HDD | 1-6 Hexane | Perstorp | Monomer | Hydroxyl/2 | Diol a3) |
| | diol | | | | |
| Solvarex ® 9 | Aromatic | Total | Solvent for the | | Solvent for the |
| | solvent | | resin | | resin |
| BG | Butyl glycol | Brenntag | Solvent for the | | Solvent for the |
| | | | resin | | resin |
| Fascat ® 4100 | Tin | PMC | Catalyst | | Catalyst |
| | monobutyl | Organometallix | | | |
| | oxide | | | | |
| Xylene | Xylene | Total | Azeotropic carrier | | Azeotropic carrier |
| | | | solvent | | solvent |

1.2) Procedure for Resin Preparation: According to the Invention (Example 1) and Comparison Test 1 without BEPD

In a 1.5 L glass reactor equipped with:
a Vigreux distillation column with a Dean Stark separator on it,
a dipping rod for adding nitrogen,
a temperature probe,
   the monomers are charged in quantities as described in Table 2.

The synthesis takes place at a maximum of 220° C. in the presence of a catalyst (Fascat® 4100: 0.08 g) and xylene as azeotropic carrier (30 g) to remove water from the reaction.

The resin according to the invention (example 1) is diluted in pure Solvarex® 9 and in a Solvarex® 9/butylglycol mixture (70/30) for the resin of comparison test 1.

The characteristics of the two resins are given in Table 2.

TABLE 2
Compositions and characteristics of resins (without
solvent, catalyst and azeotropic carrier) according
to the invention (example 1) and comparison test 1

| | | Test according to |
|---|---|---|
| | Comparison test 1 | the invention (example 1) |
| Phthalic anhydride | 706 | 555 |
| Ethylene glycol | 84 | 83 |
| Neopentyl glycol | 210 | 121 |
| BEPD | | 80 |
| (Butyl ethyl propanediol) | | |
| 1,6 Hexanediol | | 131 |
| Adipic acid | | 30 |
| TOTAL | 1000 | 1000 |
| Hydroxyl index | 30 | 37 |
| (mg KOH/g) | | |
| (ISO 2554 method) | | |
| Acid index | 4 | 4 |
| (mg KOH/g) (ISO | | |
| 2114 method) | | |
| Solids content (%) | 64.3 | 76 |
| (ISO 3251 method) | | |
| Brookfield viscosity at | 3500 | 11 700 |
| 25° C. (mPa · s) | | |
| (ISO 3219 method) at the | | |
| solids content indicated | | |
| Calculated Mn | 3050 | 2530 |

### 2) Preparation of the Resin for Finishing Coating

### 2.1) Raw Materials Used

TABLE 3
Raw materials used

| | | | | | Typical |
|---|---|---|---|---|---|
| | | | | Nature of the | composition |
| | Chemical | | Technical | function/ | according to |
| Trade name | name | Supplier | function | functionality | the invention |
| PAN | Phthalic | Polynt | Monomer | Carboxyl/2 | Diacid b1) |
| | anhydride | | | | |
| AA | Adipic acid | Bayer | Monomer | Carboxyl/2 | Diacid b2) |
| Glycerine | Glycerol | Oleon | Monomer | Hydroxyl/3 | Polyol a4) |
| NPG | Neopentyl glycol | Perstorp | Monomer | Hydroxyl/2 | Diol a2) |
| BEPD | Butyl ethyl | Perstorp | Monomer | Hydroxyl/2 | Diol a1) |
| | propanediol | | | | |
| TMP | Trimethylol | Perstorp | Monomer | Hydroxyl/3 | Polyol a4) |
| | propane | | | | |
| Solvarex ® 9 | Aromatic solvent | Total | Solvent for the | | Solvent for |
| | | | resin | | the resin |
| BG | Butyl glycol | Brenntag | Solvent for the | | Solvent for |
| | | | resin | | the resin |
| Fascat ® | Tin monobutyl | PMC | Catalyst | | Catalyst |
| 4100 | oxide | Organometallix | | | |
| Xylene | Xylene | Total | Azeotropic | | Azeotropic |
| | | | carrier solvent | | carrier solvent |

2.2) Procedure for Resin Preparation: According to the Invention (Example 2) and Comparison Test 2 without BEPD

The procedure used is identical to that described in the procedure in point 1.2) above (the proportions are given in Table 4).

The resin according to the invention (example 2) is diluted in pure Solvarex® 9 and in a Solvarex® 9/butylglycol mixture (70/30) for the resin of comparison test 2.

The characteristics of the two resins are also given in Table 4.

TABLE 4
Resin compositions and characteristics (without solvent, catalyst and
azeotropic carrier) according to the invention and comparison test

| | | Test according to the |
|---|---|---|
| | Comparison test 2 | invention (example 2) |
| Phthalic anhydride | 418 | 390 |
| Glycerol | | 15 |
| Neopentyl glycol | 343 | 340 |
| Trimethylol propane | 77 | |
| Adipic acid | 162 | 171 |
| BEPD | | 84 |
| (Butyl ethyl propanediol) | | |
| TOTAL | 1000 | 1000 |
| Hydroxyl index | 55 | 60 |
| (mg KOH/g) | | |
| (ISO 2554 method) | | |
| Acid index | 4 | 1.5 |
| (mg KOH/g) | | |
| (ISO 2114 method) | | |
| Solids content (%) | 65.5 | 75.7 |
| (ISO 3251 method) | | |
| Calculated Mn | 1760 | 1685 |
| Brookfield viscosity at 25° C. | 3500 | 5800 |
| (mPa · s) | | |
| (ISO 3219 method) at the | | |
| solids content indicated | | |

### 3) Preparation of the Resin for Backer Coating

### 3.1) Raw Materials Used

TABLE 5
Raw materials used

| | | | | | Typical |
|---|---|---|---|---|---|
| | | | | Nature of the | composition |
| | Chemical | | Technical | function/ | according to |
| Trade name | name | Supplier | function | functionality | the invention |
| PAN | Phthalic | Polynt | Monomer | Carboxyl/2 | Diacid b1) |
| | anhydride | | | | |
| AA | Adipic acid | Bayer | Monomer | Carboxyl/2 | Diacid b2) |
| EG | Ethylene | Dow | Monomer | Hydroxyl/2 | Diol a3) |
| | glycol | | | | |
| NPG | Neopentyl | Perstorp | Monomer | Hydroxyl/2 | Diol a2) |
| | glycol | | | | |
| BEPD | Butyl ethyl | Perstorp | Monomer | Hydroxyl/2 | Diol a1) |
| | propanediol | | | | |
| TMP | Trimethylol | Perstorp | Monomer | Hydroxyl/3 | Polyol a4) |
| | propane | | | | |
| Solvarex ® 9 | Aromatic C₉ | Total | Solvent for the | | Solvent for the |
| | solvent | | resin | | resin |
| | (fraction) | | | | |
| BG | Butyl glycol | Brenntag | Solvent for the | | Solvent for the |
| | | | resin | | resin |
| Fascat ® | Tin | PMC | Catalyst | | Catalyst |
| 4100 | monobutyl | Organometallix | | | |
| | oxide | | | | |
| Xylene | Xylene | Total | Azeotropic | | Azeotropic |
| | | | carrier solvent | | carrier solvent |

3.2) Procedure for Resin Preparation: According to the Invention (Example 3) and Comparison Test 3 without BEPD

The procedure used is identical to that described in point 1.2) (The proportions are given in Table 6).

The resin according to the invention (example 3) is diluted in pure Solvarex® 9 and in a Solvarex® 9/butylglycol mixture (70/30) for the resin of comparison test 3.

TABLE 6
Compositions and characteristics of the resins (without
solvent, catalyst and azeotropic carrier) according to
the invention (example 3) and comparison test 3

| | | Test according to the |
|---|---|---|
| | Comparison test 3 | invention (example 3) |
| Phthalic anhydride | 370 | 368 |
| Ethylene glycol | | 48 |
| Neopentyl glycol | 278 | 240 |
| Trimethylol propane | 219 | 99 |
| Adipic acid | 133 | 140 |
| BEPD | | 105 |
| (Butyl ethyl propanediol) | | |
| TOTAL | 1000 | 1000 |
| Hydroxyl index | 150 | 154 |
| (mg KOH/g) | | |
| (ISO 2554 method) | | |
| Acid index | 6 | 4 |
| (mg KOH/g) | | |
| (ISO 2114 method) | | |
| Solids content (%) | 67.5 | 76 |
| (ISO 3251 method) | | |
| Brookfield viscosity at 25° C. | 3800 | 4100 |
| (mPa · s) | | |
| (ISO 3219 method) at the | | |
| solids content indicated | | |
| Calculated Mn | 700 | 660 |

### 4) Application of Resins in Paints for Metal Foil

### 4.1) Metal Foil and Application Conditions for the Coating/Packaging Before Tests

The sheeting used for the tests is galvanized steel sheeting 0.75 millimetres thick, pretreated with a solution of chromate.

The paint is applied using a Bar Coater applicator. Three types of application are made:
primer coating,
top-coat coating,
backer coating.

The thickness of the top-coat coating and the backer coating on the metal sheeting is 20 μm.

In the case of the top-coat coating, the paint is applied on a metal sheeting coated with a primer coating 5 μm thick.

The resulting coated sheeting is put in a ventilated oven.

Table 7 below gives the crosslinking conditions depending on the type of coating, at 385° C.

TABLE 7
crosslinking conditions

| | | Peak T (° C.) on the | |
|---|---|---|---|
| | Oven T (° C.) | metal | Duration (s) |
| Primer | 360 | 224 | 60 |
| Top Coat | 385 | 232 | 52 |
| Backer | 385 | 232 | 52 |

The paint, as a primer coating and backer coating on the metal and applied on primer coating as a top-coat coating, is evaluated through the following performance tests, after packaging the test panels in an air-conditioned room at 23° C.±2° C. where the humidity is controlled at 50%±5%.

| | |
|---|---|
| Resistance to methyl ethyl ketone (in s) | See description below |
| or to methyl isobutyl ketone (in s) | |
| Charge 1 kg (MEK) or 500 g (MIBK)/ | |
| linear Taber | |
| Indentation test (mm) | NF EN ISO 1520 |
| Adhesion test | NF EN ISO 2409 |
| Adhesion + | NF EN 13523-6 |
| 6 mm indentation | |
| Adhesion + 6 mm indentation + | NF EN 13523-6 |
| 30 min at 90° C. | |
| T-Bend Test | NF EN 13523-7 |
| PERSOZ hardness (s) | NF EN ISO 1522 |
| Yield (g/m²) | See formula below |
| Yield gain (%) | |

The method for resistance to the solvent indicated consists in making back and forth movements on the coated sheeting with a Taber abraser device impregnated with said solvent and noting the time (in s) after which degradation in the coating is observed.

The yield is calculated according to the following formula from the dry paint density, the solids content and the coat thickness:

Yield (In g/m²)=100 multiplied by “dry paint density (g/m³)” multiplied by “the thickness of the coat of paint (m)” and the result divided by “the solids content of the paint (%)”.

The covering power (in m²/g/μ) is equal to the Inverse of the yield (in g/m²) divided by the thickness of the coat.

Yield (in g/m²)=100 multiplied by “dry paint density (g/m³)” multiplied by “the thickness of the coat of paint (m)” and the result divided by “the solids content of the paint (%)”.

### 4.2) Formulation and Preparation of a Paint for Primer Coats

TABLE 8
Formulation of the paint

| | | | Function | Supplier | Chemical name |
|---|---|---|---|---|---|
| Resin in solvent | 266 | (1) | Binder tested | see point 1.2) | Polyester |
| (according to the | | | | and Table 2) | |
| invention example 1 | | | | | |
| or comparison 1) | | | | | |
| Solvarex ® 10 LN | 38 | (2) | Solvent | Total | Aromatic hydrocarbon |
| BUTYLDIGLYCOL | 38 | (3) | Solvent | Brenntag | Ether alcohol |
| DISPERBYK ® 161 | 5 | (4) | Dispersant | BYK | Block polymer |
| KRONOS ® 2360 | 81 | (5) | Pigment | KRONOS | Titanium oxide |
| BAYFERROX ® | 5.5 | (6) | Pigment | BAYER/ | Iron oxide |
| | | | | LANXESS | |
| SHIELDEX ® C 303 | 36 | (7) | Anticorrosive | GRACE | Silica |
| | | | pigment | | |
| K-WHITE G 105 | 36 | (8) | Anticorrosive | TAYCA | Aluminum triphosphate |
| | | | pigment | | |
| POLSPERSE ® 10 | 53 | (9) | Filler | IMERYS | Kaolin |
| Aerosil ® R 972 | 10 | (10) | Rheological | EVONIK | Silica |
| | | | additive | | |
| Resin in solvent | 247 | (11) | Binder tested | see point 1.2) | Polyester |
| (according to the | | | | and Table 2) | |
| invention example 1 | | | | | |
| and comparison 1) | | | | | |
| CYMEL ® 303 LF | 50.5 | (12) | Crosslinker | ALLNEX | Melamine |
| APTS (12.5% | 7.9 | (13) | Catalyst | BASF | Para-toluenesulfonic acid |
| butanol w/w) | | | | | |
| Solvarex ® 10 LN | 59.5 | (14) | Solvent | Total | Aromatic C₁₀ |
| | | | | | hydrocarbon (fraction) |
| BUTYLDIGLYCOL | 59.5 | (15) | Solvent | Brenntag | Ether alcool |
| EPIKOTE ® 828 | 7.3 | (16) | Binder | Dow | Epoxy resin |
| TOTAL | 1000 | | | | |

In a 1 liter thermostated beaker at ambient temperature, in this order, the compounds (1), (2), (3), (4), (5), (6), (7), (8), (9) and (10) are added. This mixture is stirred using a Dispermat stirrer, then dispersed for 30 minutes at 3500 rpm in the presence of glass beads to facilitate pigment dispersion. After removing the beads for sieving, with stirring at 1000 rpm, the rest of the binder (11) and compounds (12), (13) and (16) are added. Still with stirring at 1000 rpm, the viscosity of the paint is adjusted due to the addition of (14) and (15).

The satin paint obtained presents the following characteristics (Table 9).

TABLE 9
Characteristics of the paint

| | |
|---|---|
| Density (g/cm³) | 1.23 |
| Solid by weight (%) | 57.9 (Comparison 1) |
| | 64.5 (Invention example 1) |
| VOC (g/L) | 497 (Comparison 1) |
| | 428 (Invention example 1) |
| PVC (%) | 18 |
| Cone/plane viscosity at 25° C. (m · Pas) | 410 (Comparison 1) |
| | 400 (Invention example 1) |

VOC: Volatile organic compounds
PVC: Pigment Volume Concentration

### 4.2.1) Application Results: Mechanical Properties

TABLE 10
Application results

| | Comparison 1 | Invention exemple1 |
|---|---|---|
| Resistance to methyl isobutyl | <5 | <5 |
| ketone (in s) | | |
| Charge 500 g/linear Taber | | |
| Adhesion test | 0 | 0 |
| Adhesion + 6 mm indentation | 0 | 0 |
| Adhesion + 6 mm indentation + | 0 | 0 |
| 30 min at 90° C. | | |
| T-Bend Test | 1.5 T | 1 T |
| PERSOZ hardness (s) | 280 | 200 |
| Yield (g/m²) | 13.2 | 11.5 |
| Covering power (m²/kg/μ) | 370 | 420 |
| Improvement in covering power | 0 | 13.5 |

### 4.3) Formulation and Preparation of a Top-Coat Coating Paint and a Backer Coating Paint

TABLE 11
List of ingredients for a binder with tested solids content adjusted to a solids
content of 65% with respective solvents described above, for resins according
to invention, examples 2 and 3, and according to comparison tests 2 and 3

| | | | Function | Supplier | Chemical name |
|---|---|---|---|---|---|
| Resin according to | 183.5 | (1) | Binder tested | see points 2.2) | Polyester |
| invention example 2 or | | | | and 3.2) | |
| example 3 or comparison | | | | | |
| 2 or 3 (solids content | | | | | |
| adjusted to 65%) | | | | | |
| Solvarex ® 10 LN | 12 | (2) | Solvent | Total | Aromatic C₁₀ |
| | | | | | hydrocarbon |
| | | | | | (fraction) |
| BUTYLDIGLYCOL | 12 | (3) | Solvent | Brenntag | Ether alcohol |
| DISPERBYK ® 161 | 7.5 | (4) | Dispersant | BYK | Block polymer |
| KRONOS ® 2360 | 298 | (5) | Pigment | KRONOS | Titanium oxide |
| Aerosil ® R 972 | 2.5 | (8) | Rheological | EVONIK | Silica |
| | | | additive | | |
| Resin (solids content | 260 | (7) | Binder tested | see points 2.2) | Polyester |
| 65%) | | | | and 3.2) | |
| Butyldiglycol | 8.5 | (8) | Solvent | Brenntag | Ether alcohol |
| Solvarex ® 10 LN | 8.5 | (9) | Solvent | Total | Aromatic C₁₀ |
| | | | | | hydrocarbon |
| | | | | | (fraction) |
| Syloid ® ED 40 | 34 | (10) | Filler | GRACE | Silica |
| CYMEL ® 303 LF | 56 | (11) | Crosslinker | ALLNEX | Melamine |
| APTS | 8.7 | (12) | Catalyst | BASF | Para-toluenesulfonic |
| (12.5% butanol w/w) | | | | | acid |
| Solvarex ® 10 LN | 53 | (13) | Solvent | Total | Aromatic |
| | | | | | hydrocarbon |
| BUTYLDIGLYCOL | 53 | (14) | Solvent | Brenntag | Ether alcohol |
| Crayvallac ® FLow 200 | 2 | (15) | Spreading | Arkema | Polyester |
| | | | agent | | |
| TOTAL | 1000 | | | | |

In a 1 liter thermostated beaker at ambient temperature, in this order, the compounds (1), (2), (3), (4), (5), (6) are added. This mixture is stirred using a Dispermat stirrer, then dispersed for 40 minutes at 3500 rpm. The rest of the binder (7), a part of the solvent (8) and (9) and the compound (10) are then added. Dispersion is continued for 15 minutes at 2500 rpm. Still with stirring at 1000 rpm, compounds (11) and (12) are added. The viscosity of the paint is adjusted due to the addition of solvents (13) and (14). At the end of the cycle, still with stirring at 1000 rpm, compound (15) is added.

The top-coat coating is evaluated, being applied to a mechanical sheeting previously coated with a primer coating similar to that described in point 4.2).

The semi-gloss paint obtained presents the following characteristics (Table 12).

TABLE 12
Characteristics of the semi-gloss paint for top-coat coating

| | | | | | | Cone/plane viscosity at | |
|---|---|---|---|---|---|---|---|
| | | Solids content (%) | | VOC (g/L) | | 25° C. (m · Pas) | |
| Density | PVC | Comparison | Invention | Comparison | Invention | Comparison | Invention |
| (g/cm³) | (%) | 2 | example 2 | 2 | example 2 | 2 | example 2 |
| 1.34 | 23 | 64.7 | 70.5 | 462 | 400 | 535 | 540 |

TABLE 13
Characteristics of the semi-gloss paint for backer coating

| | | | | | | Cone/plane viscosity at | |
|---|---|---|---|---|---|---|---|
| | | Solids content (%) | | VOC (g/L) | | 25° C. (m · Pas) | |
| Density | PVC | Comparison | Invention | Comparison | Invention | Comparison | Invention |
| (g/cm³) | (%) | 3 | example 3 | 3 | example 3 | 3 | example 3 |
| 1.34 | 23 | 65.3 | 72.2 | 457 | 386 | 530 | 525 |

VOC: Volatile organic compounds
PVC: Pigment Volume Concentration

### 4.3.1) Application Results: Mechanical Properties

TABLE 14
Application results

| | Top-coat coating | | Backer coating | |
|---|---|---|---|---|
| | | Invention | | Invention |
| | Comparison 2 | example 2 | Comparison 3 | example 3 |
| Resistance to methyl | >240 | >240 | >240 s | 120 s ± 10 |
| ethyl ketone (in s) | | | | |
| Charge 1 kg/linear | | | | |
| Taber | | | | |
| Indentation test (mm) | 11.4 | 11.2 | 7.4 | 10.2 |
| Adhesion test | 0 | 0 | 0 | 0 |
| Adhesion + | 0 | 0 | 2 | 0 |
| 6 mm indentation | | | | |
| Adhesion + 6 mm | 0 | 0 | 5 | 2-3 |
| indentation + | | | | |
| 30 min at 90° C. | | | | |
| T-Bend Test | 2.5 T | 2 T | 4 T | 3.5 T |
| PERSOZ hardness (s) | 223 | 187 | 267 | 242 |
| Yield (g/m²) | 53.8 | 46.5 | 53.9 | 48.5 |
| Covering power | 372 | 430 | 371 | 413 |
| (m²/kg/μ) | | | | |
| Improvement in covering | 0 | 16 | 0 | 11 |
| power (%) | | | | |

1. A polyester resin bearing at least two functions from among hydroxyl and/or carboxyl, wherein the structure of said polyester resin is branched and includes the components:
A) a polyol component comprising:
a1) at least one C₃ to C₆ diol bearing at least two lateral C₂ to C₄, alkyl substituents,
a2) at least one C₃ to C₆ diol, bearing at least one lateral methyl substituent,
a3) at least one linear C₂ to C₆ diol, bearing no lateral (alkyl) substituent,
a4) at least one polyol with functionality >2
and
B) a polyacid component comprising:
b1) at least one aromatic diacid or its anhydride,
b2) at least one linear C₄ to C₁₀ aliphatic diacid
b3) optionally, a cycloaliphatic diacid
said resin being free of any unsaturated fatty monoacid and of any unsaturated fatty monoalcohol and having a glass transition temperature measured by DSC at 10° C./min, from −10° C. to 50° C. and a calculated Mn ranging from 500 to 10,000.

2. The polyester resin as claimed in claim 1, wherein said diol a1) is 2-butyl-2-ethyl-1,3-propanediol.

3. The resin as claimed in claim 1 wherein said diol a1) represents from 3 to 25% by weight of said resin.

4. The resin as claimed in claim 1 wherein a3) is present and the a1/(a1+a2+a3) molar ratio varies from 0.1 to 0.4.

5. The resin as claimed in claim 1 wherein said polyol a2) is a diol selected from the group consisting of: neopentyl glycol (2,2-dimethyl-1,3-propanediol) and dimethyl butanediol.

6. The resin as claimed in claim 5, wherein the content of weight of said polyol a2) is less than 75% by weight of said polyol component A).

7. (canceled)

8. The resin as claimed in claim 1 wherein the acid component B) of said resin comprises at least one cycloaliphatic carboxylic diacid b3) or its anhydride.

9. The resin as claimed in claimed 1 wherein said resin has a hydroxyl index or a carboxyl index or a global hydroxyl+carboxyl index ranging from 10 to 200 mg KOH/g.

10. The resin as claimed in claimed 1 wherein said resin is hydroxylated.

11. The resin as claimed in claim 1 having a (calculated) Mn ranging from 1000 to 10 000.

12. A resin solution comprising at least one resin according to claim 1 and an organic solvent of said resin.

13. The resin solution as claimed in claim 12, wherein the content by weight of said resin relative to the total resin+solvent weight is greater than 60%.

14. A crosslinkable binder composition comprising as binder at least one polyester resin according to claim 1.

15. The composition as claimed in claim 14, comprising at least one organic solvent with the content of said resin ranging from 60% to 90% relative to the total resin+solvent weight.

16. The composition of claim 14 which is a coating composition.

17. The composition as claimed in claim 16, further comprising at least one crosslinking agent bearing groups that react with the hydroxyl and/or carboxyl groups borne by said resin.

18. The composition as claimed in claim 17, wherein said crosslinking agent is selected from the group consisting of melamine, polyisocyanate, polyanhydride, and polysilane, when said resin is hydroxylated or said crosslinking agent is selected from the group consisting of polyepoxides and polyols when said resin is carboxylated.

19. (canceled)

20. The composition as claimed in claim 14 further comprising at least one pigment.

21. (canceled)

22. (canceled)

23. (canceled)

24. (canceled)

25. (canceled)

26. (canceled)

27. A coating characterized in that it results from the use of at least one resin as defined according to one of claims 1 to 11, of a resin solution as defined according to claim 12 or 13 or of a coating composition as defined according to one of claims 14 to 20.

28. The coating as claimed in claim 27, characterized in that it is a metal foil (“coil”) coating.

29. The resin as claimed in claim 1 wherein said diol a) is a C₃ or C₄ diol.

30. The resin as claimed in claim 1, wherein the b1/b2 molar ratio ranges from 1/1 to 4/1.
